(19) United States
(12) Patent Application Publication
(10) Pub. No.: US 2026/0358502 A1
(43) Pub. Date: Nov. 12, 2026

(54) LIMAR TRACKING SYSTEM AND METHODS THEREOF

(71) Applicant: Munro Design & Technologies, LLC, Ontario, NY (US)

(72) Inventor: James F. MUNRO, Ontario, NY (US)

(21) Appl. No.: 19/670,076

(22) Filed: May 7, 2026

Related U.S. Application Data
(60) Provisional application No. 63/803,131, filed on May 9, 2025.

(51) Int. Cl. G01S 17/89; G01S 17/66

(52) U.S. Cl. CPC G01S 17/89; G01S 17/66

(57) ABSTRACT

Methods and systems for tracking a target with an active 3D imaging system is disclosed. The target tracking is determined by localizing a target's position within successive 3D images and computing the difference in localized position as a function of time.

This application claims the benefit of U.S. Provisional Patent Application No. 63/803,131, filed May 9, 2025, which is hereby incorporated by reference in its entirety

### FIELD

This technology generally relates to systems and methods for optical three-dimensional imaging of distant targets and, more particularly, to systems and methods for optically imaging and tracking distant objects at video frame rates with high-accuracy and precision.

### BACKGROUND

When it is necessary to detect and then track objects or targets that are at a considerable distance, such as greater than 500 meters, then generally a radar (radio detection and ranging) technology is employed. A radar system 1, such as that depicted if FIG. 1, comprises a sturdy base 2 onto which is mounted a Y-rotary stage 4 which rotates about an axis 6, such as the Y-axis, onto which is typically mounted a gimbal stage 8 which rotates about an axis in the X-Z plane. Affixed to gimbal stage 8 is a transmitter and receiver system which can include a parabolic antenna 10 and which transmits and then receives radio energy along axis 12. Note that by virtue of Y-rotary stage 4 and gimbal stage 6 that axis 12 can be pointed into any direction within the hemisphere above the X-Z plane which can, for example, be ground level or the surface of a body of water.

In operation, a short pulse of radio energy is transmitted from the transmitter of radar system 1 into the direction of axis 12 through parabolic antenna 10. Because of diffraction, the beamwidth of the transmitted radio energy is greater than 1° and is often up to 5° or more in width. If a down-range object is present anywhere in the beam of transmitted radio energy, and if the object is reflective to the transmitted radio energy, (e.g., the object contains electrically conductive components), then the object will reflect a portion of the radio energy incident upon it back to the radar system 1 where it is collected and focused by parabolic antenna onto a receiver and then electronically processed. As part of the processing, radar system 1 can determine the range to the object by measuring the round trip time of flight of the radio pulse, t_{tof}, and plugging that value into the formula R=ct_{tof}/2 to determine R, the range, where c is the speed of light and is approximately equal to 3×10⁸ m/s. Further, by knowing the rotation angles of Y-rotary stage 4 and gimbal rotary stage 6, then the direction of axis 12 is also known from which the location of the target object within the beamwidth of the beam about radar system 1 can be determined. Note, however, that a radar system is a point-to-point system: that is, the radar system 1 is a point in space and the target object is also a point in space, and the radar system can determine the distance between these two points and the vectoral relationship therebetween but no image data of the target is provided. To generate an image of the target object, or to determine the cross-range location of the target object with a precision better than the beam-width of the emission, it is necessary to scan or sweep the axis 12 across the target object, which is time consuming and not particularly accurate, especially if the target is moving and/or the emission beam is broad.

While radar systems can detect cooperative targets at extremely long range with good down-range range accuracy, they typically have poor cross-range resolution which makes tracking small uncooperative targets extremely challenging. Further, these deficiencies are rooted in the relatively long wavelength of the radio frequencies employed in radar and the small area of the parabolic antenna 10. Accordingly, examples of the technology provide a system and method for overcoming the limitations of conventional radar systems for detecting, localizing, and tracking objects at range with excellent precision in all three axes, even if the target has little or no metallic or conductive components or is otherwise a poor reflector of radar emissions.

### SUMMARY

Accordingly, examples of the technology, hereinafter referred to LIMAR, an acronym for Light IMaging And Ranging, can quickly localize a target in all three axis or dimensions (i.e., 3D) within the envelope of the emission without scanning the emission, wherein the localization is accurate and fast.

A three-dimensional LIMAR tracking system includes a first rotation stage that rotates about a first axis, a second rotation stage that rotates about a second axis, a 3D imager that produces a 3D image of a field of view having a target being tracked, and an emission source. The system also includes a processing system is coupled to the first rotation stage, the second rotation stage, the 3D imager, and the emission source. The processing system further comprises a memory comprising programmed instructions stored thereon and one or more processors configured execute the stored programmed instructions to: determine a range to the target by the 3D imager; determine an azimuthof the target by a rotation angle of the first rotation stage and a location of the target within the 3D image; and determine an elevation angle of the target by a rotation angle of the second rotation stage and the location of the target within the 3D image.

A three-dimensional tracking system includes a first rotation stage device configured to rotate about a first axis, a second rotation stage device configured to rotate about a second axis, and a 3D imager configured to produce 3D image data of a field of view. A processing system is coupled to the first rotation stage, the second rotation stage, and the 3D imager. The processing system further comprises a memory comprising programmed instructions stored thereon and one or more processors configured execute the stored programmed instructions to: determine when a target is within a field of view based on the 3D image data of the field of view generated by the 3D imager from a reflected portion of optical energy emitted by emission sources; determine a position of the target along the axes without scanning across the target, when the determination indicates the target is within the field of view; and determine and output a location of the target based on the determined position of the target along the axes and an obtained location of the 3D imager.

A method for making a three-dimensional tracking system includes providing a first rotation stage device configured to rotate about a first axis, a second rotation stage device configured to rotate about a second axis, and a 3D imager configured to produce 3D image data of a field of view. A processing system is coupled to the first rotation stage, the second rotation stage, and the 3D imager, wherein the processing system further comprises a memory comprising programmed instructions stored thereon and one or more processors configured execute the stored programmed instructions to: determine when a target is within a field of view based on the 3D image data of the field of view generated by the 3D imager from a reflected portion of optical energy emitted by the emission sources; determine a position of the target along the axes without scanning across the target, when the determination indicates the target is within the field of view; and determine and output a location of the target based on the determined position of the target along the axes and an obtained location of the 3D imager.

### BRIEF DESCRIPTION OF THE DRAWINGS

FIG. 1 is a diagram of a prior art target detection and tracking system;

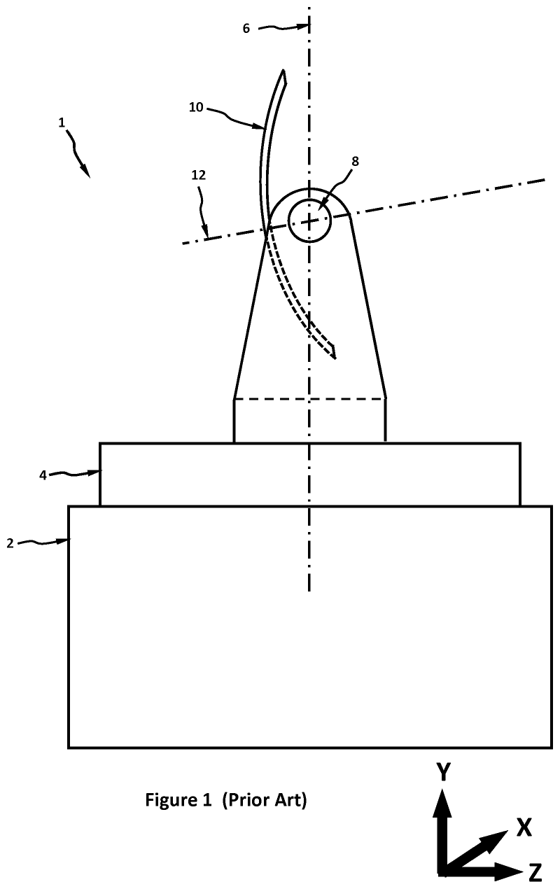

FIG. 2 is a front-view illustration of a system for detecting and tracking a target in accordance with examples of this technology;

FIG. 3 is a side-view illustration of a system for detecting and tracking a target in accordance with examples of this technology;

FIG. 4 is a block diagram of a LIMAR system of a detection and tracking system in accordance with examples of this technology;

FIG. 5 is a side view of an image intensifier having a micro-channel plate in accordance with examples of this technology;

FIG. 6 is a side view of an alternate image intensifier configuration that does not have a micro-channel plate in accordance with examples of this technology;

FIG. 7 is a block diagram of a detection and tracking system in accordance with examples of this technology;

FIG. 8 is an illustration of the geometry and math for computing the elevation of a target in accordance with examples of this technology;

FIG. 9 is an illustration of the geometry and math for computing the azimuth of a target in accordance with examples of this technology; and

FIG. 10 is an illustration of an output screen of a detection and tracking system displayed to a user in accordance with examples of this technology.

### DETAILED DESCRIPTION

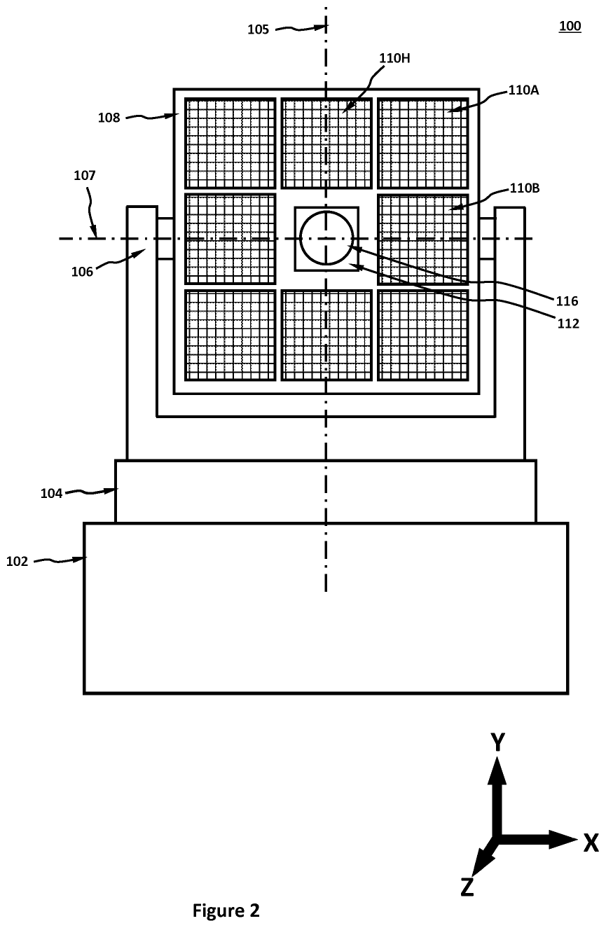

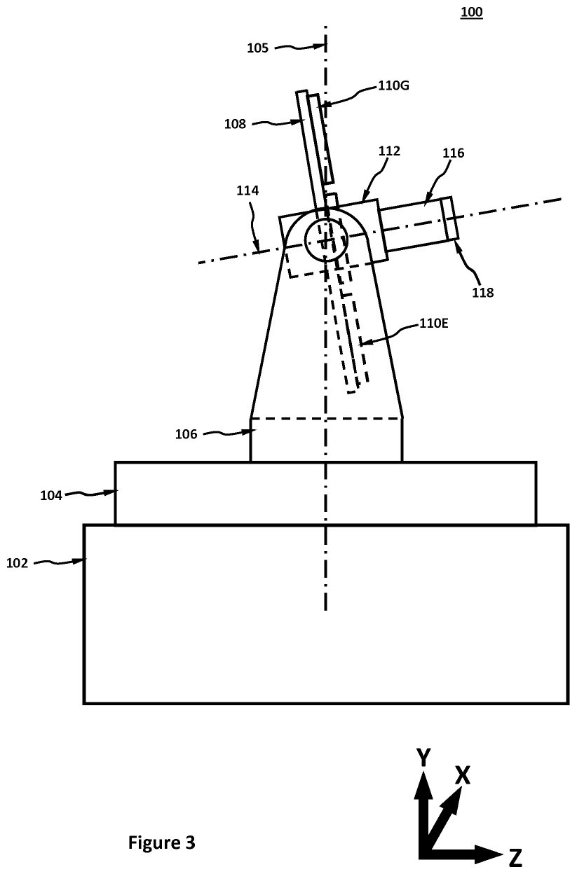

An example of a LIMAR (Light IMaging And Ranging) tracking system 100 is illustrated in FIG. 2 and can comprise a base 102 onto which is mounted a Y-rotary stage 104 that rotates about the Y-axis 105, onto which is mounted a gimbal rotary stage 106 that rotates about horizontal axis 107, onto which is mounted mounting plate 108 that also rotates about horizontal axis 107. Mounting plate 108 in turn can be coupled to LIMAR (Light IMaging And Ranging) camera head 112 having an objective lens 116 and optical filter 118; mounting plate 108 can also be coupled to one or more emitter arrays 110 such as emitter array 110A, emitter array 110B, and so on. Referring for the moment to FIG. 3, LIMAR tracking system 100 can also include optical axis 114 which is the imaging axis of LIMAR camera head 112 and its objective lens 116; optical axis 114 can substantially intersect horizontal axis 107 and Y-axis 105 at a point-like location which can be designated as the origin point about which LIMAR tracking system 100 scans through a hemisphere or hyper-hemisphere for target detection during operation as described further, below. To be clear, a LIMAR system is a 3D imaging system, or 3D camera, and is a key sub-system of LIMAR tracking system 100.

Continuing with reference to FIGS. 2 and 3, base 102 provides a firm, stable, substantially non-moving and substantially non-vibrating platform onto which the stages, optics, and electronics comprising LIMAR tracking system 100 are mounted. Base 102 can be permanent in nature and designed to be immobile over the lifetime of LIMAR tracking system 100, or base 102 can be mobile in nature and have wheels, particularly retractable wheels, that allow LIMAR tracking system 100 to be transported from location to location. If immobile, base 102 can be installed such that it rests atop bedrock, or base 102 can be as simple as a post, or a plurality of posts, embedded in the ground in concrete. Base 102 can also include a vertical protrusion such as a mast such that Y-rotary stage 104 and all stages, optics, and electronics comprising LIMAR tracking system 100 installed above Y-rotary stage 104 are a significant height above the bottom of base 102, such as greater than 2 meters, 5 meters, or even 10 meters, or in some examples preferably 15 meters such that horizontal axis 107 can be at or above obscuring debris such as scrub, shrubs, or trees such that the scanned field of view of LIMAR tracking system 100 is minimally obstructed or not obstructed at all.

Continuing with reference to FIGS. 2 and 3, Y-rotary stage 104 is installed atop base 102, and coupled to base 102, and all stages, optics, and electronics comprising LIMAR tracking system 100 installed above Y-rotary stage 104 and is configured to rotate about an axis, such as a vertical axis such as Y-axis 105. Y-rotary stage 104 is in some examples preferably capable of rotating a full 360° about Y-axis 105 and do so at a rate greater than one revolution per second. Y-rotary stage 104 must also be able to support the weight of the stages, emitters, optics, and electronics comprising LIMAR tracking system 100 installed above Y-rotary stage 104, and be able to accept communications from digital processor 200 that commands Y-rotary stage 104 to rotate to a certain azimuthal angle with a pointing accuracy better than 0.1° or in some examples preferably better than 0.01° for any rotational position of Y-rotary stage 104. Y-rotary stage 104 also in some examples preferably has a highly-accurate positional read-back mechanism, such as a rotary encoder, that provides feedback to digital processor 200 about the actual angular rotational position of Y-rotary stage 104 both while it is stationary as well as when it is rotating. The read-back mechanism provides information to digital processor 200 necessary for determining the azimuthal direction and bearing of down-range target 126 as will be described later.

Continuing with reference to FIGS. 2 and 3, gimbal rotary stage 106 can be installed atop Y-rotary stage 104 and coupled to Y-rotary stage 104, and the optics and electronics comprising LIMAR tracking system 100 installed above gimbal rotary stage 106 can be configured to rotate about an axis, such as a horizontal axis 107. Gimbal rotary stage 106 is in some examples preferably capable of rotating a full 180°about horizontal axis 107 and do so at a rate greater than 180° per second. Gimbal rotary stage 106 must also be able to support the weight of the optics and electronics comprising LIMAR tracking system 100 installed above gimbal rotary stage 106 and be able to accept communications from digital processor 200 that command gimbal rotary stage 106 to rotate to a certain elevation angle with a pointing accuracy better than 0.1° or in some examples preferably better than 0.01° for any rotational position of gimbal rotary stage 106. Gimbal rotary stage 106 also in some examples preferably has a highly-accurate positional read-back mechanism, such as a rotary encoder, that provides feedback to digital processor 200 about the actual angular rotational position of gimbal rotary stage 106 both while it is stationary as well as when it is rotating. The read-back mechanism provides information to digital processor 200 necessary for determining the elevation and changes in elevation of down-range target 126 as will be described later.

Coupled to gimbal rotary stage 106 is mounting plate 108 which is a substantially rigid framework onto which the emitter arrays 110A through 110H (collectively referred to hereinafter as emitter array 110) and LIMAR camera head 112 are mounted. The number of individual emitter arrays, such as emitter array 110A, can be between one and 100, and each emitter array comprises at least one emitter of optical energy. Further, LIMAR camera head 112 is mounted onto mounting plate 108 and the imaging axis of the LIMAR camera head 112 and accompanying objective lens 114 can be parallel to, or in some examples preferably coaxial with, optical axis 114 of LIMAR tracking system 100, and further the emitter arrays composing emitter array 110 are mounted onto mounting plate 108 such that the emission axes of the emitters within the emitter arrays are substantially parallel to optical axis 114 as well, although the emission axes of the emitters within the emitter arrays 110 can be purposely angularly offset (i.e., not parallel) with optical axis 114 to effect a certain down-range illumination pattern. Further, one or more emitter arrays, such as emitter array 110A or emitter array 110B can be angularly offset so they do not lie in the plane orthogonal to optical axis 114 to effect a certain down-range illumination pattern.

The purpose of an emitter array is to generate modulated optical energy of a prescribed beamwidth and wavelength and project that optical energy into a desired direction. An emission element, such as light emitter 120, has a corresponding emission lens 122 that can be used to broaden or make narrower the emission beam generated by a light emitter 120. A light emitter 120 can be an LED (Light Emitting Diode), a SLED (Super-luminescent Light Emitting Diode), or a diode laser such as a VCSEL (Vertical Cavity Surface Emitting Laser). Light emitter 120 in some examples preferably emits monochromatic or near-monochromatic light that matches the passband of optical filter 118 and has a wavelength emission bandwidth less than 1 nm. Further, the output of light emitter 120 is in some examples preferably modulatable by varying the voltage applied to or the current passing through emitter 120 at a frequency between 10 kHz (30,000 meters wavelength) and 1 GHz (3 meters wavelength). The emission of light emitter 120 is in some examples preferably of a wavelength that the photocathode of image intensifier 150 is responsive to, such as between 400 nm and 940 nm, although many commercially available light emitters 120 emit 850 nm light. The peak emission power of a light emitter 120 is in some examples preferably greater than 1 Watt, or in some examples more preferably greater than 5 Watts, and the emission modulation waveform can be substantially sinusoidal, a sum of sinusoids of different frequencies, pulsed, bursted, chirped, or even substantially piecewise linear. A width of the active emission area of light emitter 120 is in some examples preferably less than 5 mm, in other examples more preferably less than 1 mm, or in yet other examples ideally less than 0.5 mm so the effects of optical etendue do not significantly impact the down-range width of the beam's emission profile.

The number of light emitters 120 within an emitter array 110 such as emitter array 110A or emitter array 110B can be between 2 and 625, and the emitter arrays are in some examples preferably arranged on a grid as shown in FIG. 2. Each light emitter 120 can be mounted onto a circuit board and can produce significant amounts of heat, up to 30 Watts of heat (for each light emitter 120) that must be removed from the emitter array 110 such that the emitters do not overheat or change their emission wavelengths due to the dλ/dT effects common to many semiconductor emission devices (if a light emitter 120 heats up excessively its emission wavelength may change to the extent that it falls outside of the passband of optical filter 118). Accordingly, the heat can be removed from the light emitters 120 by conducting the heat away from the light emitters 120 through the circuit board with metal vias embedded in the circuit board immediately behind a light emitter 120. Cooling fins or heat sinks can be installed on the rear-side of the circuit board to dissipate the heat with cooling fans through convection to the surrounding atmosphere. Alternately, the rear-side of the circuit board can be enclosed with a manifold that is filled with a coolant wherein the coolant is then circulated into the manifold through an input port and out of manifold through an output port in a cooling circuit that includes a chiller 214. In this manner the temperature of the coolant cooled by the chiller 214 can be precisely controlled so that the temperature of the light emitters 120 does not change significantly from the preferred operating temperature in some examples. Note that as is the case with most circuit boards, electronic components such as voltage regulators, amplifiers, and transistors comprising emitter driver 146 that are used to electronically drive light emitter 124, can be installed on the rear side of the circuit board as well as the front side of the circuit board.

On the emission side of a light emitter 120 is an emission lens 122 arranged such that each light emitter 120 has a corresponding emission lens 122. In general, an emission lens 122 can be substantially centered on the emission axis of its corresponding light emitter 120, and serves to narrow, widen, or otherwise change the illumination pattern of the emitted light 124 down-range. For example, the emission pattern can be changed from having a Gaussian cross-sectional profile to a so-called top-hat profile in which the irradiance or the intensity of the emission is substantially constant over a large portion of the emission beam instead of having a broad central peak. An array of light emitter 120 and emission lens 122 pairs can be configured to form an emitter array such as emitter array 110A or emitter array 110 C. One or more emission lenses 122 within an array of emitters lenses of an emitter array such as emitter array 110A can all have the same prescription or the prescriptions can vary to further tailor the down-range illumination pattern. The emission lenses 120 can have planar, concave, convex, spherical, aspherical, prescription, have rotational symmetry or not have rotational symmetry, or even free-form surface prescriptions, have optical power, and have a focal length greater than 10 mm or less than −10 mm. Ideally in some examples emission lenses 122 are slightly underfilled with emitted light so that none of the light emitted by an emitter 120 falls outside the aperture of an emission lens 122 and is lost.

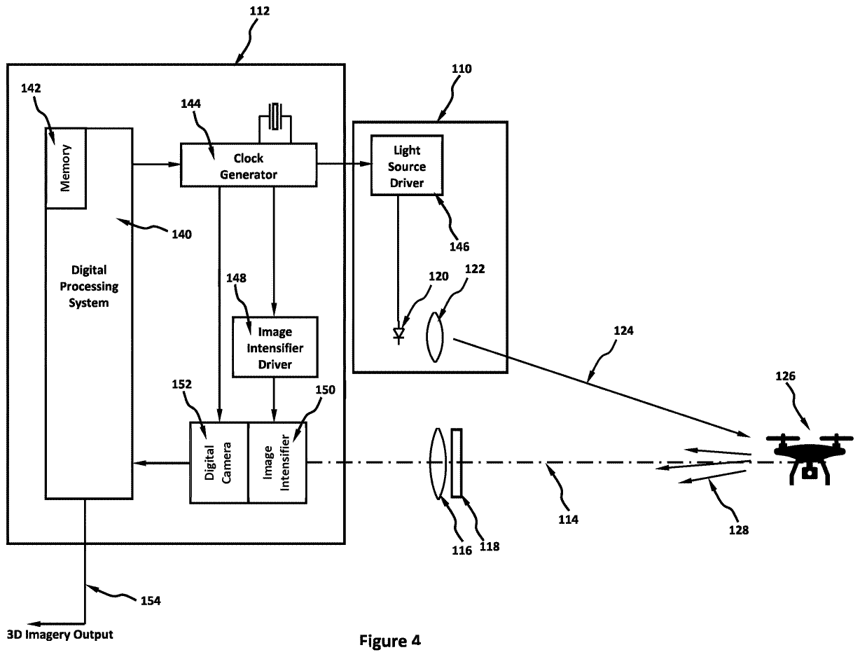

LIMAR camera head 112 of LIMAR tracking system 100 will now be described with reference to FIG. 4. As seen in FIG. 4, LIMAR camera head 112 can comprise a digital processor 140 having an output coupled to an input of a clock generator 144 which has outputs coupled to an input of an image intensifier driver 148 and an input of a digital camera 152; image intensifier driver 148 in turn has an output coupled to an input of image intensifier 150 which in turn also has an optical output coupled to an input of digital camera 152 which has an output coupled to an input of digital processor 140 which has an electronic output line 154 carrying 3D imagery to digital processor 200 of LIMAR tracking system 100. Note that clock generator 144 can also have an output coupled to an input of light source driver 146 which has an output coupled to a light emitter 120 of an emitter array such as emitter array 110A which can be located adjacent to LIMAR camera head 112 within LIMAR tracking system 100.

Clock generator 144 under the control of digital processor 142 produces three signals that are central to the operation of LIMAR tracking system 100: 1) a light source drive signal output to the light source driver 146 that is used to control the output of a light emitter 120; this signal can be sinusoidal, a sum of sinusoids, a coherent burst waveform, or even pulsed (for “flash-mode” operation), and the amplitude of the emitted light 124 can be substantially modulated in accordance with the instantaneous amplitude of the drive signal; 2) an image intensifier drive signal output to the image intensifier driver 148 that is used to control the gain of the image intensifier 150; this signal can also be sinusoidal, a sum of sinusoids, a coherent burst waveform, or even pulsed (for “flash-mode” range-gating operation), and the amplitude of the image intensifier 150 can be substantially modulated in accordance with the instantaneous amplitude of the image intensifier drive signal; and 3) a shutter signal for controlling the shutter timing of digital camera 152 such that the points in time at which the shutter of digital camera 152 opens and closes is precisely controlled. Importantly, the timing of these three signals are highly synchronized with one another. Note that in an FPGA implementation of digital processor 140, the clock generator 144 can be integrated into digital processor 140.

Memory 142 can store data and programmed instructions executed by digital processor 140 for creating three-dimensional imagery, although some or all of these instructions and data may be stored elsewhere. A variety of different types of memory storage devices, such as a random access memory (RAM), a read only memory (ROM), hard disk, CD ROM, USB thumb-drive, or other computer readable medium which is read from and/or written to by a magnetic, optical, or other reading and/or writing system coupled to digital processor 140 can be used for memory 142.

Continuing with reference to FIG. 4, a portion of back-reflected light 128 reflected from a target 126 is incident on optical filter 118 which allows the back-reflected light 128 to pass through largely unattenuated but substantially blocks or attenuates all other wavelengths of electromagnetic radiation that the photocathode of image intensifier 150 is responsive to. As a result, only the electromagnetic emission generated by an emitter 120 and reflected by target 126 is allowed to reach the image intensifier 150. This increases the signal-to-noise ratio of the optical signal incident on the image intensifier 150. Importantly, the passband of optical filter 118 must substantially match the emission wavelength of light emitter 120 so the desired light passes through optical filter 118 and do so even when light emitter 120 is operative and generating significant amounts of heat. It is well known that the emission wavelength of most semiconductor emitters, including VCSELs, change when their operating temperature changes, and since the change in temperature due to heating may cause the emission wavelength to change to the extent that the emission wavelength falls outside the pass-band of optical filter 118, then care must be taken to ensure that the operating temperature of light emitter 120 does not change appreciably during operation of LIMAR tracking system 100.

Not only must the passband of optical filter 118 match the emission wavelength of an emitter 120, such as 940 nm, 850 nm, or 810 nm, the optical passband of optical filter 118 is in some examples preferably as small as possible to limit the amount of unwanted optical light noise that passes through optical filter 118 which degrades the SNR of the LIMAR tracking system 100. The optical passband of optical filter 118 can be as small as 2 nm, or in some examples preferably less than 1 nm (assuming the operating temperature of light emitter 120 is well controlled), although passbands as great as 5 nm or even 10 nm may be acceptable as well.

Objective lens 116 serves to focus back-reflected light 128 from objects or a target 126 within the field of view of objective lens 116 onto the photocathode of image intensifier 150. The ability of objective lens 116 to capture large amounts of back-reflected light 128 from a target 126 at range is proportional to the area of the aperture of objective lens 116, and accordingly the aperture of objective lens 116 is generally desired to be as large as possible, such as at least 25 mm wide, or in some examples more preferably greater than 100 mm or even 200 mm wide. It is necessary that objective lens 116 is operative with the substantially monochromatic wavelength of light emitted by light emitter 120, such as 850 nm, and not operative with other wavelengths of light which can greatly simplify the design of objective lens 116. However, to improve the versatility of lens objective 116, objective lens 116 in some examples preferably has focus and aperture adjustments, as well as focal length (i.e., zoom) adjustability. Indeed, the focus, aperture, and focal length operations can be motorized and controlled by digital processor 140. The variable range of focus can be from 1meter down-range to infinity, or the focus can be fixed and set to a hyperfocus value. The focal length can vary from 25 mm to 3000 mm or more, and the field of view can be from 0.1° included angle up to 40° included angle, although a range of from 1° included angle up to 10° included angle can be a good match with the emission envelope of the emitted light 124 exiting from an emitter array such as emitter array 110A.

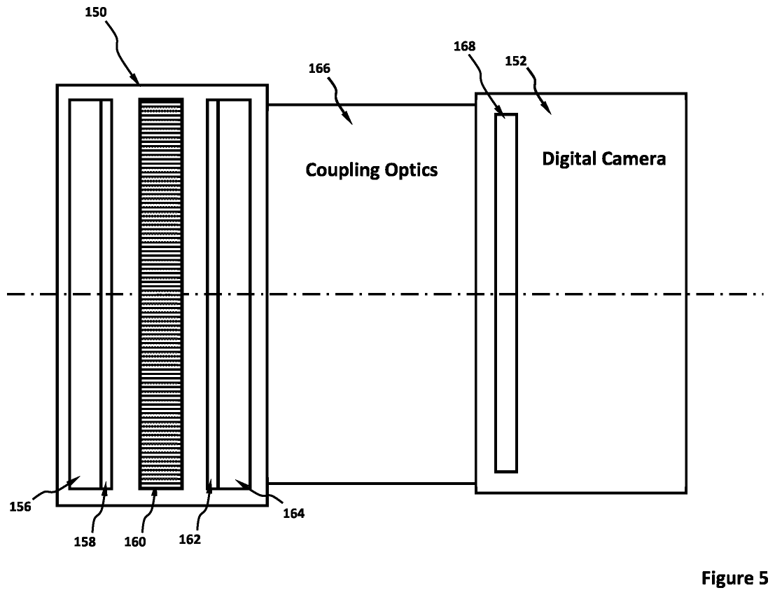

Image intensifier 150 serves to intensify the weak back-reflected light 128 signal received from target 126 as well as to demodulate the back-reflected light 128 incident on the photocathode of the image intensifier. The image intensifier device used for this purpose can be any one of several possible configurations. As shown in FIG. 5, for example, image intensifier 150 can comprise a substantially transparent glass window 156 on which is installed a photocathode 158 with a micro-channel plate 160 that amplifies the current stream generated by photocathode 158 which is then incident on phosphor screen 162 that converts the amplified electron stream into photons that exit through output window 164 and pass through coupling optics 166 and form an image on image sensor 168 of digital camera 152. Coupling optics 166 can be a coherent fiber optical bundle, for example, or a relay lens. Note that in this configuration the photocathode 158, micro-channel plate 160, and phosphor screen 162 are positioned within a substantially vacuum environment to allow for the flow of electrons within image intensifier 150 while image sensor 168 resides outside of the vacuum environment.

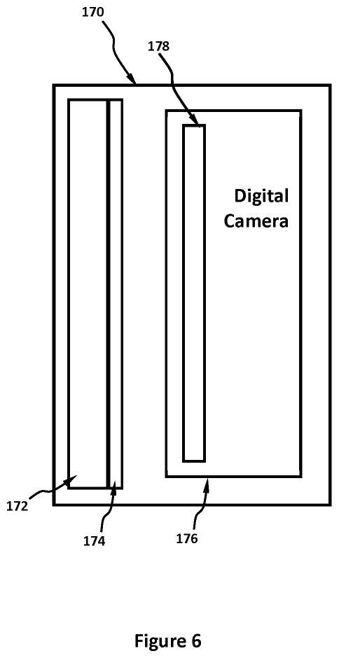

An alternate image intensifier 170 configuration, as shown in FIG. 6, can comprise an input window 172 on which is installed a photocathode 174 and an image sensor 178. Importantly, photocathode 174 and image sensor 178 are positioned within a substantially vacuum environment to allow for the flow of electrons from photocathode 174 to image sensor 178 within image intensifier 170. Further, a large acceleration voltage, such as 1000V can be applied between photocathode 174 and image sensor 178 (or a layer or screen that is at least partially conductive in front of image sensor 178) that accelerates the electrons from photocathode 174 to image sensor 178 thereby imparting additional energy to the electrons such that they generate multiple charge carries, up too 100-fold or more, within a pixel of image sensor 178 thereby causing an electron amplification process. Further, the gain of the amplification process can be controlled by varying the magnitude of the accelerating voltage such that the modulated back-reflected light 128 incident on the photocathode 174 of image intensifier 170 can be demodulated. Note that a micro-channel plate is not used in this image intensifier 170 configuration.

In another image intensifier configuration (not shown) a photocathode, micro-channel plate, optional phosphor screen, and image sensor can all reside within a vacuum environment. In this case the image sensor can be operative with photons if the phosphor screen is present or operative with electrons directly from the micro-channel plate if the phosphor screen is not utilized.

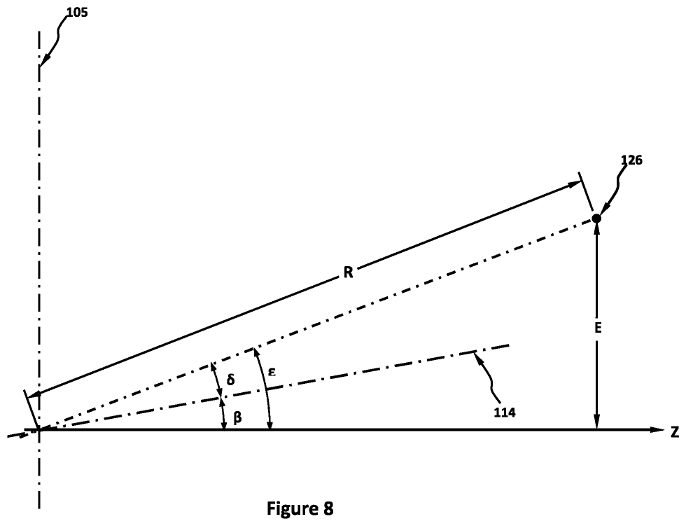

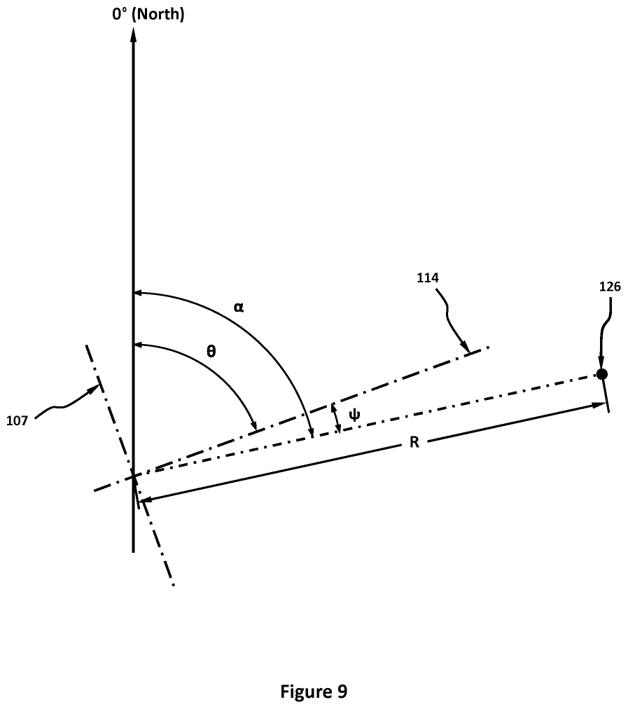

Importantly, the relationship between the field-of-view angle of objective lens 116 and pixel location within digital camera 152 as a function of the focal length of objective lens 116 must be known, or calibrated, especially if objective lens 116 is a multi-focal zoom lens. The relationship between the field-of-view angle and pixel location within digital camera 152 as a function of the focal length of objective lens 116 can be characterized at the factory before installation of LIMAR camera head 112 into LIMAR tracking system 100, and the characterization data can be stored in a non-volatile portion of memory 142 and recalled when the vertical field angle δ and horizontal field angle ψ of a target 126 need to be determined as described below in connection with FIG. 8 and FIG. 9. Further, the relationship between the optical distortion, such as barrel or pincushion distortion, of objective lens 116 as a function of field angle and focal length of objective lens 116 must be known, or calibrated, especially if objective lens 116 is a multi-focal zoom lens. The relationship between the field-of-view angle and optical distortion as a function of the focal length of objective lens 116 can be characterized at the factory before installation of LIMAR camera head 112 into LIMAR tracking system 100, and the distortion characterization data can be stored in a non-volatile portion of memory 142 and recalled when the relative elevation and azimuthal angles of a target 126 need to be determined with utmost precision.

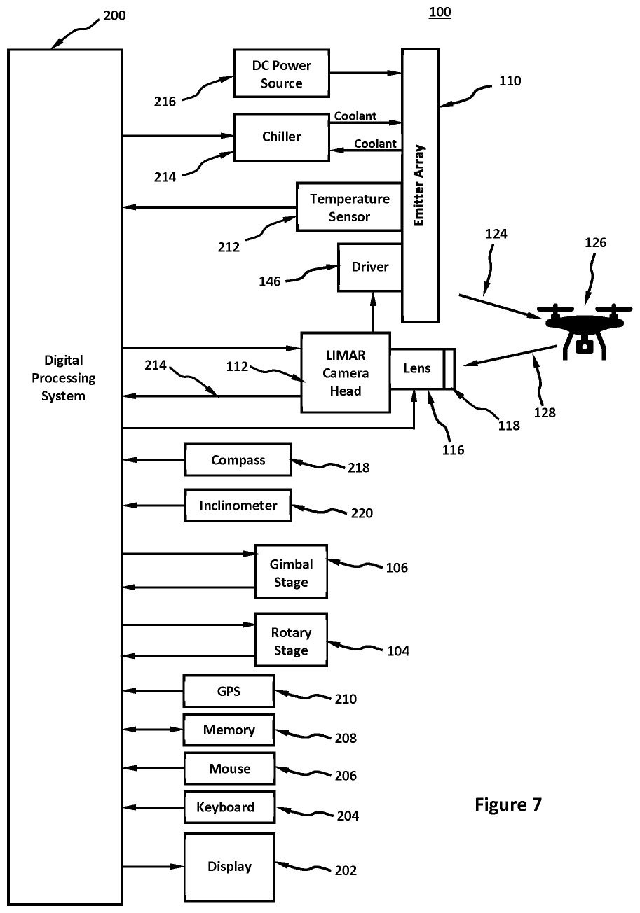

The electronic components and interconnects within LIMAR tracking system 100 will now be further described with reference to FIG. 7. As seen in FIG. 7 digital processor 200 can have an output coupled to an input of display 202, an input coupled to an output of a keyboard 204, an input coupled to an output of a computer mouse 206, a computer bus coupled to memory 208, an input coupled to an output of a GPS (global positioning system) receiver 210, an output coupled to an input of Y-rotary stage 104 over which rotation commands are provided, an input coupled to an output of Y-rotary stage 104 over which rotation status and other data are provided, an output coupled to an input of gimbal rotary stage 106 over which rotation commands are provided, an input coupled to an output of gimbal rotary stage 106 over which rotation status and other data are provided, an output coupled to an input of objective lens 116 through which aperture, zoom, and/or focus commands are provided, an output coupled to an input of LIMAR camera head 112 through which 3D imaging commands are provided, an input coupled to LIMAR camera head output line 154 through which 3D image data is communicated, an input coupled to an output of temperature sensor 212 indicating a temperature of an emitter array such as emitter array 110A, an output coupled to an input of chiller 214, an input coupled to an output of inclinometer 220 and an input coupled to an output of compass 218, although other input and outputs coupled to other devices peripheral to digital processor 200 can be utilized as well.

DC power source 216 provides direct-current electrical power to an emitter array such as emitter array 110A at a level sufficient to drive each and every light emitter 120 within the emitter array. The amount of electrical power can be substantial. For example, if the VD-0850I-006W VCSEL from BrightLaser is used as light emitter 120, which nominally draws 9.5 Amps of current at 2.7V for approximately 26 Watts each, and if 100 of these VCSELs are used in an emitter array such as emitter array 110A, then DC power source 216 has to provide 2600 Watts of power for each emitter array. Note that if four such VCSELs are connected in series so that their combined voltage drop is on the order of 10.8V, then DC power source can provide a standard 12V output voltage. In this case the electrical current required from DC power source 216 would be 2.7 A×100/4=67.5 Amps. DC power source can utilize electricity generated with solar photovoltaic, wind, gasoline or diesel based generator, batteries, or power from the grid. DC power source 216 can provide voltages between 3.0 volts and 120 Volts, and currents between 1 Amp and 1000 Amps. Multiple DC power sources 216 can be utilized if necessary to provide power to the light emitters of LIMAR tracking system 100.

If, as stated in the preceding paragraph, some 2600 Watts of electrical power is provided to an emitter array such as emitter array 110A, and if each VD-0850I-006W VCSEL output 6 Watts of optical power for a total of 600 Watts, then 2600-600=2000 Watts of heat must be removed from an emitter array in order for an emitter array to operate at a steady non-elevated temperature needed to maintain the stability of the emission wavelength as stated earlier. The excessive heat can be removed with finned heat-sinks and blower fans such that the heat is dissipated into the ambient air surrounding an emitter array. However, it can be difficult to economically remove 2000 Watts of heat through air-cooling necessitating the use of liquid cooling and the use of a chiller 214 in the liquid cooling circuit. Temperature sensor 212 can provide temperature feedback information of an emitter array such as emitter array 110A to digital processor 200 which in turn can be used to control the flow rate of the coolant through the coolant circuit associated with chiller 214 to maintain the desired temperature of light emitters 120 within an emitter array.

LIMAR tracking system 100 may be mobile, portable, or semi-portable, and can be transported to different locations as needed. The absolute location of LIMAR tracking system 100 is needed (in terms of latitude, longitude, and elevation, for example) in order to determine the precise location of a target 126 (again, in terms of latitude, longitude, and elevation, for example). One way to determine the precise location of LIMAR tracking system 100 is with GPS receiver 210. The positioning output data provided by GPS receiver 210 is input to digital processor 200 and is used by the programming within digital processor 200 (said programming can be stored in memory 208) along with 3D image data provided to digital processor 200 by LIMAR camera head 112 through camera head output line 154-to determine the precise location of target 126 as described further below in connection with FIG. 8 and FIG. 9.

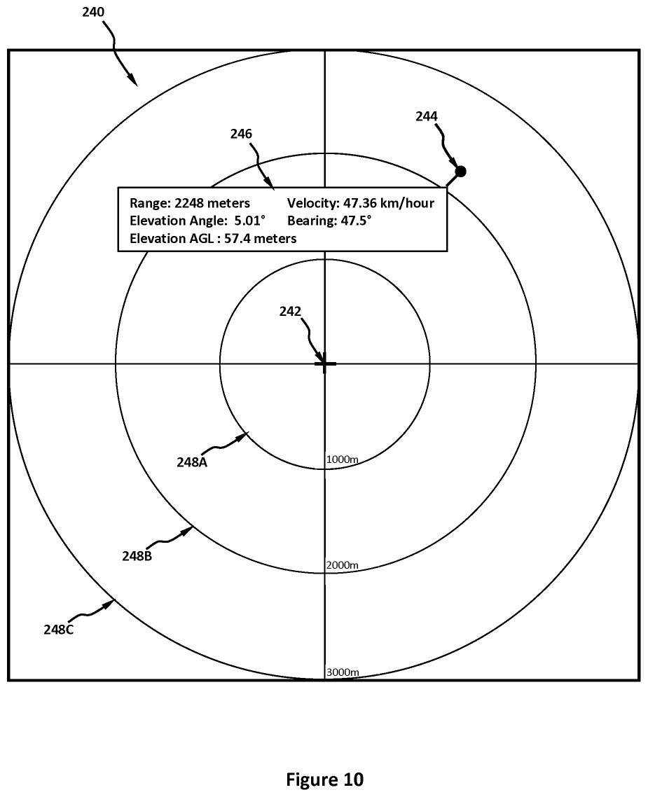

Mouse 206 and keyboard 204 together allow a user of LIMAR tracking system 100 to input data into a program executing within digital processor 200 or to control the execution of a program executing within digital processor 200. Data or control information can include, for example, the scanning envelope of LIMAR tracking system 100 which digital processor 200 can then use to control the angular scan range of Y-rotary stage 104 and gimbal rotary stage 106. The data entered into LIMAR tracking system 100 through the use of mouse 206 and keyboard 204 can be shown on display 202 and verified to be accurate and correct by the user as the data is being entered. Display 202 can also provide status information to the user such as, for example, the temperature of an emitter array such as emitter array 110A or the status of LIMAR camera head 112. Perhaps most importantly, display 202 can provide positional and tracking data of a target 126 as shown in FIG. 10 and as described further below.

Memory 208 can store programmed instructions and data for processing three-dimensional imagery and target 126 tracking as described and illustrated herein for execution by the digital processor 200, although some or all of these instructions and data may be stored elsewhere. A variety of different types of memory storage devices, such as a random access memory (RAM), a read only memory (ROM), hard disk, CD ROM, USB thumb-drive, or other computer readable medium which is read from and/or written to by a magnetic, optical, or other reading and/or writing system coupled to the processing unit, can be used for memory 208.

In operation a user or operator installs LIMAR tracking system 100 into its desired location and powers up LIMAR tracking system 100. Then when powered up digital processor 200 commands Y-rotary stage 104 to its home position and obtains readback from Y-rotary stage 104 that Y-rotary stage 104 is indeed at its home position (alternately compass 218 can provide azimuthal data of Y-rotary stage 104). Digital processor 200 can also command gimbal rotary stage 106 to its home position and obtain readback from gimbal rotary stage 106 that gimbal rotary stage 106 is indeed at its home position (alternately inclinometer 220 can provide elevation angle data of gimbal rotary stage 106). Digital processor 200 can also obtain positioning information from GPS receiver 210 and store it in memory 208 so that digital processor 200 can use knowledge of its absolute location to determine the absolute location of a target 126 as will be described later. Digital processor 200 can also activate chiller 214 which then circulates coolant through one or more emitter arrays such as emitter array 110A. Status information of any or all of the preceding operations can be presented on display 202.

Next a user or operator can use keyboard 204 and/or mouse 206 to enter commands into digital processor 200 to commence LIMAR scanning and 3D-imaging operations with the intent of finding a target 126 down-range within the scanning field of view of the LIMAR tracking system 100. Digital processor 200 can also adjust the focus, zoom, and aperture settings of objective lens 116 and activate LIMAR camera head 112 whereafter LIMAR camera head 112 generates drive signals for light emitters 120 such that light emitters 120 begin to emit optical radiation whose amplitude varies in accordance with the drive signal output by emitter driver 146. At this juncture Y-rotary stage 104 and gimbal rotary stage 106 are further activated by digital processor 200 and commence to cause LIMAR camera head 112 on optical axis 114 and emitter arrays such as emitter array 110A to scan through the scan envelope entered into digital processor 200 as prescribed by the user. During this time the field of view of LIMAR camera head 112 is partially or fully illuminated—or even over—illuminated-by optical energy emitted by one or more light emitters 120 of an emitter array such as emitter array 110A, and during this time LIMAR camera head 112 is generating 3D imagery of any objects or targets 126 within its field of view that is illuminated by the optical energy emitted by an emitter 120 of an emitter array such as emitter array 110A and outputting the 3D imagery through camera head output line 154 to digital processor 200.

The program executing in digital processor 200 then analyzes the stream of 3D imagery received from LIMAR camera head 112 to determine if an object of interest is present within the current field of view determined by the rotation angles of Y-rotation stage 104, gimbal rotation stage 106 and objective lens 116. The determination of the presence of an object of interest or target 126 can be accomplished by inspection of a monochrome amplitude image output by LIMAR camera head 112. If an object is determined to be present within the current field of view, then a distance image output by LIMAR camera head 112 through camera head output line 154 is inspected by digital processor 200 and the range, denoted as R in FIG. 8 and FIG. 9, to the target 126 is determined from the distance image. Next, digital processor 200 further inspects the amplitude image and can perform a centroiding function to determine the exact pixel location, or sub-pixel location, of the image of the target 126 on the image sensor of digital camera 152. Next, digital processor 200 recalls from memory 208 the zoom-dependent (i.e., focal length dependent) relationship between pixel location and field angle in the field-of-view, and computes the vertical field angle, δ as shown in FIG. 8, and the horizontal field angle, ψ as shown in FIG. 9, to determine the angular location of target 126 relative to optical axis 114. Next, digital processor 200 can recall from memory 208 the zoom-dependent (i.e., focal length dependent) relationship between pixel location and optical distortion of objective lens 116 and adjusts the computed vertical field angle, δ as shown in FIG. 8, and the horizontal field angle, ψ as shown in FIG. 9, to determine the precise angular location of target 126 relative to optical axis 114.

The program executing in digital processor 200 can then input angular readback data from Y-rotary stage 104 (and/or digital processor 200 can then input data from compass 218) such as angle θ in FIG. 9, and then computes an accurate estimate of the azimuthal angle, α, of target 126 from the equation:

α=θ+Ψ Equation 1.

The program executing in digital processor 200 can then input angular readback data from gimbal rotary stage 106 (and/or digital processor 200 can then input data from inclinometer 220) such as angle β in FIG. 8, and then computes an accurate estimate of the elevation angle, ε, of target 126 from the equation:

ε=β+δ Equation 2.

To summarize, the range to target 126 from LIMAR tracking system 100 is obtained from the distance image map output by LIMAR camera head 112, the target's 126 elevation angle relative to LIMAR tracking system 100 is determined by angular readback data from gimbal rotary stage 106 or inclinometer 220 and the amplitude image map output by LIMAR camera head 112, and the target's 126 azimuthal angle relative to LIMAR tracking system 100 is determined by angular readback data from Y-rotary stage 104 or compass 218 and the amplitude image map output by LIMAR camera head 112. The location of target 126 relative to LIMAR tracking system 100 is determined using a spherical coordinate system, which can be readily converted to a cylindrical or recti-linear coordinate system using conversion methods well known in the art.

In some cases it is beneficial to know the absolute location of target 126 in global geo-spatial coordinates and not in a LIMAR tracking system 100-centric coordinate system. Once the location of a target 126 is known relative to LIMAR tracking system 100, then digital processor 200 can obtain GPS data from GPS receiver 210 (or recall the GPS location data of LIMAR tracking system 100 from memory 208), and add the GPS location of LIMAR tracking system 100 to the relative location of target 126 to obtain an absolute location of target 126 with respect to, for example, sea level, the prime meridian, and the equator for elevation or altitude, longitude, and latitude, respectively.

Further, by inspecting successive frames of 3D imagery from LIMAR camera head 112, the program executing on digital processor 200 can determine changes in range, changes in relative azimuth, and changes in elevation angle from which changes in elevation above sea level (also known as the climb angle), the bearing or heading of target 126, and the velocity of target 126 can be determined. Importantly, this computed target information can be presented to a user on display 202 as illustrated in FIG. 10 in which a displayed image 240 can have an imaged target 244 shown relative to a central boresight cross-hair 242 and, for example, annotated with data about the target 244 such as the target's range, velocity, elevation angle, bearing, and elevation in a target information box 246.

Further, LIMAR tracking system 100 is not limited to detecting, imaging, and/or tracking a single target 126, but multiple targets, and do so whether the targets reside within the current field of view of LIMAR camera head 112 or whether they reside outside the current field-of-view in which case they are detected and/or tracked when the LIMAR tracking system 100 is scanned. Indeed, within the entire scan volume of LIMAR tracking system 100 up to 1000 or more targets such as target 126 can be detected, imaged, and/or tracked. Further, some or all of the plurality of targets can be shown in the displayed image 240. Otherwise, if only one target 126 is being tracked, then displayed image 240 presents data of only one target and the displayed image is rather sparse.

Target 126 can be a manned or unmanned aerial object, such as an aircraft or a drone. Target 126 can also be a manned or unmanned marine object, such as a surface-borne boat. Target 126 can also be a manned or unmanned ground object, such as a tank or truck. Target 126 can also be a manned or unmanned space object, such as a space station or satellite.

It must be emphasized that unlike conventional radar systems that must scan the emission beam back and forth across a target object to localize its position (in so doing, for example, the target's return-signal drop-off as function of scan angle is noted for left-to-right and right-to-left scans, and the targets azimuth is half-way between equal-power points for the two scans), whereas for LIMAR tracking system 100 no such scans are needed. That is if a target 126 is within the field of view of camera head 112 and objective lens 116 then its position in all three axes can be determined immediately as described above from Equation 1 and Equation 2. This is a key differentiator of LIMAR tracking system 100 over the prior art.

Nonetheless, as with a conventional radar system which has a narrow beam-width, LIMAR tracking system 100 can also have a relatively narrow field of view. For both radar and LIMAR systems therefore, scanning of the beam/field-of-view is necessary to garner full coverage of the space, such as a hemisphere, surrounding the radar or LIMAR system.

To facilitate differing ranges to target 126, one or more emitter arrays such as emitter array 110A can be turned on or off as needed to save power and/or to prevent saturation of image intensifier 150. For example, if target 126 is relatively close to LIMAR tracking system 100, such as 100 meters or less, then only one or two emitter arrays such as emitter array 110A can be actively emitting emitted light 124, although if target 126 is a long distance away from LIMAR tracking system 100, such as three kilometers or more, then two or more emitter arrays such as emitter array 110A may be required to emit enough emitted light 124 to successfully detect and track target 126. The ability to activate and deactivate one or more emitter arrays such as emitter array 110A can substantially improve the dynamic range of LIMAR tracking system 100.

A mode of operation of LIMAR camera head 112 and light emitter 110 for producing 3-dimensional imagery is described in U.S. Pat. No. 8,254,665 titled Systems For Capturing Three-Dimensional One Or More Images And Methods thereof, which is included by reference in its entirety herein. In another mode of operation of LIMAR camera head 112 and light emitter 110 the operation of clock generator 144 is described in U.S. Pat. No. 11,598,849 titled Signal Generating Systems For Three-Dimensional Imaging Systems And Methods Thereof, which is included by reference in its entirety herein. In another mode of operation of LIMAR camera head 112, implementations and operations of digital processor 140 are described in U.S. Pat. No. 11,016,179 titled Digital Image Processing Systems For Three-Dimensional Imaging Systems With Image Intensifiers And Methods Thereof, which is included by reference in its entirety herein. The ability of the LIMAR tracking system 100 to operate with CW waveforms for great accuracy as well as with pulsed or “flash” waveforms for operating in the presence of veiling obscurants such as rain or smoke is described in U.S. Pat. No. 11,428,786 titled Dual Waveforms For Three-Dimensional Imaging Systems and Methods Thereof, which is included by reference in its entirety herein. The ability of LIMAR tracking system 100 to operate with coherent burst waveforms for great accuracy and long range as well as good power efficiency is described in U.S. Pat. No. 7,202,941 titled Apparatus For High Accuracy Distance And Velocity Measurement And Methods Thereof, which is included by reference in its entirety herein. Importantly, when 3D imagery is produced within digital processor 140 in accordance with one or more of the cited references, the produced 3D imagery is electronically communicated through camera head output line 154 to digital processor 200 as shown in FIG. 7. The frame rate of 3D imagery produced by LIMAR camera head 112 and output through camera head output line 154 can be between 2 and 1000 3D image frames of data per second (i.e., much greater than the standard 30 frames per second for video), and the brightness and/or distance images comprising a 3D image frame can have a pixel count of from 320×400 pixels up to 16,000×20,000 pixels.

Having thus described the basic concept of the invention, it will be rather apparent to those skilled in the art that the foregoing detailed disclosure is intended to be presented by way of example only and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations, such as arrows in the diagrams therefore, is not intended to limit the claimed processes to any order or direction of travel of signals or other data and/or information except as may be specified in the claims. Accordingly, the invention is limited only by the following claims and equivalents thereto.

What is claimed is:

1. A three-dimensional tracking system, the system comprising:
a first rotation stage device configured to rotate about a first axis;
a second rotation stage device configured to rotate about a second axis;
a 3D imager configured to produce 3D image data of a field of view; and
a processing system coupled to the first rotation stage, the second rotation stage, and the 3D imager, wherein the processing system further comprises a memory comprising programmed instructions stored thereon and one or more processors configured execute the stored programmed instructions to:
determine when a target is within a field of view based on the 3D image data of the field of view generated by the 3D imager from a reflected portion of optical energy emitted by emission sources;
determine a position of the target along the axes without scanning across the target, when the determination indicates the target is within the field of view; and
determine and output a location of the target based on the determined position of the target along the axes and an obtained location of the 3D imager.

2. The system as set forth in claim 1 wherein for the determine when the target is within the field of view, the one or more processors are configured to execute the stored programmed instructions further comprising programmed instructions to:
inspect an amplitude image output from the 3D image data of the field of view to determine when the target is within the field of view.

3. The system as set forth in claim 1 wherein for the determine the position of the target, the one or more processors are configured to execute the stored programmed instructions further comprising programmed instructions to:
determine a range to the target based on the 3D image data of the field of view;
determine an azimuth of the target based on a rotation angle of the first rotation stage and a location of the target within the 3D image data; and
determine an elevation angle of the target based on a rotation angle of the second rotation stage and the location of the target within the 3D image data, wherein the position of the target in the field of view is determined based on the range to the target, the azimuth, and the rotation angle.

4. The system as set forth in claim 1 wherein the one or more processors are configured to execute the stored programmed instructions further comprising programmed instructions to
obtain location of the 3D imager from a GPS receiver.

5. The system as set forth in claim 1 wherein the 3D imager further comprises an image intensifier.

6. The system as set forth in claim 5 wherein for the initiate the emission sources, the one or more processors are configured to execute the stored programmed instructions further comprising programmed instructions to:
amplitude modulate at least one of a gain of image intensifier and an emission of each of the emission sources.

7. The system as set forth in claim 6 wherein a frequency of the amplitude modulation is between 10 kHz and 2 MHz.

8. The system as set forth in claim 1 wherein a wavelength of the optical energy is between 0.40 and 10.0 micrometers.

9. The system as set forth in claim 1 wherein the 3D imager further comprises an objective lens positioned between a 3D imaging device and an optical filter.

10. The system as set forth in claim 9 wherein the optical filter comprises a bandpass filter having a pass-bandwidth less than 10 nm and wherein an emission wavelength of the emission sources is within the passband of the optical filter.

11. The system as set forth in claim 1 wherein the emission sources are arranged in a plurality of emission modules.

12. The system as set forth in claim 11 wherein a number of the emission sources in one of the emission modules is between 2 and 10,000.

13. The system as set forth in claim 11 wherein a number of the emission modules is between 2 and 1000.

14. The system as set forth in claim 11 wherein the emission modules each further comprise emission driver electronics.

15. The system as set forth in claim 11 further comprising a cooling systems positioned to place a liquid coolant adjacent the one or more emission sources.

16. The system as set forth in claim 1 wherein the emission sources are VCSELs.

17. The system as set forth in claim 1 wherein the emission sources further comprise an array of lenses in a one-to-one correspondence with each of the emission sources.

18. The system as set forth in claim 17 wherein the array of lenses are configured so that a half-power half-angle beamwidth of the optical energy exiting is less than 1°.

19. The system as set forth in claim 17 wherein the array of lenses are configured so that a half-power half-angle beamwidth of the optical energy exiting the array of lenses is between 1° and 15°.

20. The system as set forth in claim 11 wherein the optical power output emitted by each of the emission modules is between 1 and 10,000 Watts.

21. A method for making a three-dimensional tracking system, the method comprising:
providing a first rotation stage device configured to rotate about a first axis;
providing a second rotation stage device configured to rotate about a second axis;
providing a 3D imager configured to produce 3D image data of a field of view; and
coupling a processing system to the first rotation stage, the second rotation stage, and the 3D imager, wherein the processing system further comprises a memory comprising programmed instructions stored thereon and one or more processors configured execute the stored programmed instructions to:
determine when a target is within a field of view based on the 3D image data of the field of view generated by the 3D imager from a reflected portion of optical energy emitted by the emission sources;
determine a position of the target along the axes without scanning across the target, when the determination indicates the target is within the field of view; and
determine and output a location of the target based on the determined position of the target along the axes and an obtained location of the 3D imager.

22. The method as set forth in claim 21 wherein for the determine when the target is within the field of view, the one or more processors are configured to execute the stored programmed instructions further comprising programmed instructions to:
inspect an amplitude image output from the 3D image data of the field of view to determine when the target is within the field of view.

23. The method as set forth in claim 21 wherein for the determine the position of the target, the one or more processors are configured to execute the stored programmed instructions further comprising programmed instructions to:
determine a range to the target based on the 3D image data of the field of view;
determine an azimuth of the target based on a rotation angle of the first rotation stage and a location of the target within the 3D image data; and
determine an elevation angle of the target based on a rotation angle of the second rotation stage and the location of the target within the 3D image data, wherein the position of the target in the field of view is determined based on the range to the target, the azimuth, and the rotation angle.

24. The method as set forth in claim 21 wherein the one or more processors are configured to execute the stored programmed instructions further comprising programmed instructions to
obtain location of the 3D imager from a GPS receiver.

25. The method as set forth in claim 21 wherein the providing 3D imager further comprises providing an image intensifier.

26. The method as set forth in claim 25 wherein for the initiate the emission sources, the one or more processors are configured to execute the stored programmed instructions further comprising programmed instructions to:
amplitude modulate at least one of a gain of image intensifier and an emission of each of the emission sources.

27. The method as set forth in claim 26 wherein a frequency of the amplitude modulation is between 10 kHz and 2 MHz.

28. The method as set forth in claim 21 wherein a wavelength of the optical energy is between 0.40 and 10.0 micrometers.

29. The method as set forth in claim 21 wherein the providing the 3D imager further comprises positioning an objective lens between a 3D imaging device and an optical filter.

30. The method as set forth in claim 29 wherein the optical filter comprises a bandpass filter having a pass-bandwidth less than 10 nm and wherein an emission wavelength of the emission sources is within the passband of the optical filter.

31. The method as set forth in claim 21 wherein the providing the emission sources further comprises arranging the plurality of emission sources in a plurality of emission modules.

32. The method as set forth in claim 31 wherein a number of the emission sources in one of the emission modules is between 2 and 10,000.

33. The method as set forth in claim 31 wherein a number of the emission modules is between 2 and 1000.

34. The method as set forth in claim 31 wherein the providing the emission modules each further comprise providing emission driver electronics.

35. The method as set forth in claim 31 further comprising providing a cooling systems positioned to place a liquid coolant adjacent the one or more emission sources.

36. The method as set forth in claim 21 wherein the emission sources are VCSELs.

37. The method as set forth in claim 21 wherein the providing the emission sources further comprise providing an array of lenses in a one-to-one correspondence with each of the emission sources.

38. The method as set forth in claim 37 wherein the array of lenses are configured so that a half-power half-angle beamwidth of the optical energy exiting is less than 1°.

39. The method as set forth in claim 37 wherein the array of lenses are configured so that a half-power half-angle beamwidth of the optical energy exiting the array of lenses is between 1° and 15°.

40. The method as set forth in claim 31 wherein the optical power output emitted by each of the emission modules is between 1 and 10,000 Watts.

41. A three-dimensional tracking system, the system comprising:
a first rotation stage device configured to rotate about a first axis;
a second rotation stage device configured to rotate about a second axis;
a 3D imager configured to produce 3D image data of a field of view; and
a processing system coupled to the first rotation stage, the second rotation stage, and the 3D imager, wherein the processing system further comprises a memory comprising programmed instructions stored thereon and one or more processors configured execute the stored programmed instructions to:
determine a range to the target by the 3D imager;
determine an azimuth of the target by a rotation angle of the first rotation stage and a location of the target within the 3D image; and
determine an elevation angle of the target by a rotation angle of the second rotation stage and the location of the target within the 3D image.
